(19) United States
(12) Patent Application Publication
(10) Pub. No.: US 2009/0097006 A1
(43) Pub. Date: Apr. 16, 2009

(54) Apparatus and Method for Obtaining Information Indicative of the Uniformity of a Projection System of a Lithographic Apparatus

(75) Inventor: Bob STREEFKERK, Tilburg (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 12/247,052

(22) Filed: Oct. 7, 2008

Related U.S. Application Data
(60) Provisional application No. 60/978,989, filed on Oct. 10, 2007.

(51) Int. Cl. G03B 27/52; G01B 9/08

(52) U.S. Cl. 355/67; 356/124

(57) ABSTRACT

Apparatus and methods are used to obtain information indicative of the uniformity of a projection system of a lithographic apparatus. An electromagnetic radiation beam is directed toward a projection system such that the radiation beam passes from a first end of the projection system to a second end of the projection system. The electromagnetic radiation beam is subsequently directed back toward the projection system such that the electromagnetic radiation beam passes from the second end of the projection system to the first end of the projection system. At least a part of the electromagnetic radiation beam is detected after the electromagnetic radiation beam has passed back through the projection system to obtain information indicative of the uniformity of the projection system.

### CROSS-REFERENCE TO RELATED APPLICATIONS

This application claims the benefit of U.S. Provisional Application No. 60/978,989 filed Oct. 10, 2007, which is incorporated herein by reference in its entirety.

### BACKGROUND

1. Field of the Invention

The present invention relates to an apparatus and a method for measuring uniformity in elements of a lithographic apparatus.

2. Related Art

A lithographic apparatus is a machine that applies a desired pattern onto a substrate or part of a substrate. A lithographic apparatus can be used, for example, in the manufacture of flat panel displays, integrated circuits (ICs) and other devices involving fine structures. In a conventional apparatus, a patterning device, which can be referred to as a mask or a reticle, can be used to generate a circuit pattern corresponding to an individual layer of a flat panel display (or other device). This pattern can be transferred onto all or part of the substrate (e.g., a glass plate), by imaging onto a layer of radiation-sensitive material (e.g., resist) provided on the substrate.

Instead of a circuit pattern, the patterning device can be used to generate other patterns, for example a color filter pattern or a matrix of dots. Instead of a mask, the patterning device can be a patterning array that comprises an array of individually controllable elements. The pattern can be changed more quickly and for less cost in such a system compared to a mask-based system.

A flat panel display substrate is typically rectangular in shape. Lithographic apparatus designed to expose a substrate of this type can provide an exposure region that covers a full width of the rectangular substrate, or covers a portion of the width (for example half of the width). The substrate can be scanned underneath the exposure region, while the mask or reticle is synchronously scanned through a beam. In this way, the pattern is transferred to the substrate. If the exposure region covers the full width of the substrate then exposure can be completed with a single scan. If the exposure region covers, for example, half of the width of the substrate, then the substrate can be moved transversely after the first scan, and a further scan is typically performed to expose the remainder of the substrate.

In order to ensure that a pattern is uniformly applied to a substrate, elements of the lithographic apparatus that control properties of a radiation beam used to apply the pattern to the substrate should be as uniform as possible. Also, the lithographic apparatus as an entire system should be as uniform as possible. The term “uniform,” as described herein, does not necessarily imply that the radiation beam has the same properties throughout its cross-section. Instead, the term “uniform” may be an indication of how a property of the radiation beam changes due to non-uniformities in the elements of the lithographic apparatus.

For example, it may desirable to obtain information indicative of the uniformity of the elements of a patterning device, and of a patterning device as a whole, to determine whether the radiation beam has been patterned as intended. Elements of a patterning device may have certain voltages applied to them in order to impart a specific pattern in the cross-section of a radiation beam. Over time, an orientation or a position of these elements may change in response to an applied voltage, and as such, the uniformity of the patterning device may change over time. Such changes may result from wear and tear of the patterning device or due to an accumulation of dirt, for example. Further, it may also be desirable to obtain information indicative of the uniformity of an illumination system (i.e., an illuminator) of a lithographic apparatus or a set of projection optics (i.e., a projection system) that project a patterned radiation beam onto a substrate.

In conventional apparatus, information indicative of the uniformity of elements of the lithographic apparatus may be obtained by monitoring a radiation beam that passes through or reflects off these elements. Existing techniques, however, do not have the required flexibility or resolution to obtain information indicative of uniformity of specific elements of the lithographic apparatus with sufficient detail.

Therefore, what is needed is a system and method that are sufficiently flexible and have sufficient resolution to obtain information indicative of uniformity of elements of a lithographic apparatus to a specified level of detail.

### SUMMARY

In one embodiment, there is provided a method for obtaining information indicative of the uniformity of a projection system of a lithographic apparatus. The method directs a beam of radiation toward a projection system such that the radiation beam passes from a first end of the projection system to a second end of the projection system. The method subsequently directs the beam of radiation back toward the projection system, such that the beam of radiation passes from the second end of the projection system to the first end of the projection system. The method detects at least a part of the beam of radiation to obtain information indicative of the uniformity of the projection system.

In another embodiment, there is provided a lithographic apparatus comprising an illumination system configured to produce a beam of radiation, a patterning device configured to pattern the beam of radiation, and a projection system configured to project the patterned beam onto a target portion of a substrate. The lithographic apparatus also includes a first directing apparatus configured to direct the beam of radiation toward the projection system, wherein the beam of radiation passes from a first end of the projection system to a second end of the projection system. Further, a second directing apparatus is arranged to direct the beam of radiation back toward the projection system, wherein the beam of radiation passes from the second end of the projection system to the first end of the projection system. Further, the lithographic apparatus includes a detector that detects at least a part of the beam of radiation to obtain information indicative of the uniformity of the projection system.

In yet another embodiment, there is provided a computer-readable medium containing instructions for controlling at least one processor by a method that directs a beam of radiation toward a projection system such that the radiation beam passes from a first end of the projection system to a second end of the projection system. The method also comprises directing the beam of radiation back toward the projection system, such that the beam of radiation passes from the second end of the projection system to the first end of the projection system. Further, the method detects at least a part of the electromagnetic radiation beam to obtain information indicative of the uniformity of the projection system.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1 and 2 depict lithographic apparatus, according to various embodiments of the present invention.

FIG. 3 depicts a mode of transferring a pattern to a substrate according to one embodiment of the invention as shown in FIG. 2.

FIG. 4 depicts an arrangement of optical engines, according to one embodiment of the present invention.

FIG. 5 depicts the lithographic apparatus of FIG. 1.

FIGS. 6, 7, and 8 depict exemplary apparatus for obtaining information indicative of the uniformity of elements of a lithographic apparatus.

FIG. 9 depicts an exemplary method for obtaining information indicative of the uniformity of elements of a lithographic apparatus.

FIG. 10 depicts an exemplary computer system upon which the present invention may be implemented.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment cannot necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention can be implemented in hardware, firmware, software, or any combination thereof. Embodiments of the invention can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium can include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

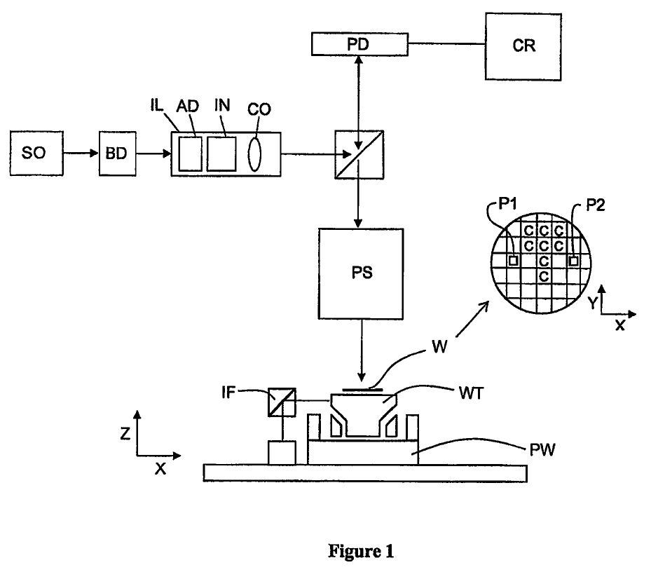

FIG. 1 schematically depicts the lithographic apparatus 1 of one embodiment of the invention. The apparatus comprises an illumination system IL, a patterning device PD, a substrate table WT, and a projection system PS. The illumination system (illuminator) IL is configured to condition a radiation beam B (e.g., UV radiation).

It is to be appreciated that, although the description is directed to lithography, the patterned device PD can be formed in a display system (e.g., in a LCD television or projector), without departing from the scope of the present invention. Thus, the projected patterned beam can be projected onto many different types of objects, e.g., substrates, display devices, etc.

The substrate table WT is constructed to support a substrate (e.g., a resist-coated substrate) W and connected to a positioner PW configured to accurately position the substrate in accordance with certain parameters.

The projection system (e.g., a refractive projection lens system) PS is configured to project the beam of radiation modulated by the array of individually controllable elements onto a target portion C (e.g., comprising one or more dies) of the substrate W. The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein can be considered as synonymous with the more general term “projection system.”

The illumination system can include various types of optical components, such as refractive, reflective, magnetic, electromagnetic, electrostatic or other types of optical components, or any combination thereof, for directing, shaping, or controlling radiation.

The patterning device PD (e.g., a reticle or mask or an array of individually controllable elements) modulates the beam. In general, the position of the array of individually controllable elements will be fixed relative to the projection system PS. However, it can instead be connected to a positioner configured to accurately position the array of individually controllable elements in accordance with certain parameters.

The term “patterning device” or “contrast device” used herein should be broadly interpreted as referring to any device that can be used to modulate the cross-section of a radiation beam, such as to create a pattern in a target portion of the substrate. The devices can be either static patterning devices (e.g., masks or reticles) or dynamic (e.g., arrays of programmable elements) patterning devices. For brevity, most of the description will be in terms of a dynamic patterning device, however it is to be appreciated that a static pattern device can also be used without departing from the scope of the present invention.

It should be noted that the pattern imparted to the radiation beam cannot exactly correspond to the desired pattern in the target portion of the substrate, for example if the pattern includes phase-shifting features or so called assist features. Similarly, the pattern eventually generated on the substrate cannot correspond to the pattern formed at any one instant on the array of individually controllable elements. This can be the case in an arrangement in which the eventual pattern formed on each part of the substrate is built up over a given period of time or a given number of exposures during which the pattern on the array of individually controllable elements and/or the relative position of the substrate changes.

Generally, the pattern created on the target portion of the substrate will correspond to a particular functional layer in a device being created in the target portion, such as an integrated circuit or a flat panel display (e.g., a color filter layer in a flat panel display or a thin film transistor layer in a flat panel display). Examples of such patterning devices include reticles, programmable mirror arrays, laser diode arrays, light emitting diode arrays, grating light valves, and LCD arrays.

Patterning devices whose pattern is programmable with the aid of electronic means (e.g., a computer), such as patterning devices comprising a plurality of programmable elements (e.g., all the devices mentioned in the previous sentence except for the reticle), are collectively referred to herein as “contrast devices.” The patterning device comprises at least 10, at least 100, at least 1,000, at least 10,000, at least 100,000, at least 1,000,000, or at least 10,000,000 programmable elements.

A programmable mirror array can comprise a matrix-addressable surface having a viscoelastic control layer and a reflective surface. The basic principle behind such an apparatus is that addressed areas of the reflective surface reflect incident light as diffracted light, whereas unaddressed areas reflect incident light as undiffracted light. Using an appropriate spatial filter, the undiffracted light can be filtered out of the reflected beam, leaving only the diffracted light to reach the substrate. In this manner, the beam becomes patterned according to the addressing pattern of the matrix-addressable surface.

It will be appreciated that, as an alternative, the filter can filter out the diffracted light, leaving the undiffracted light to reach the substrate.

An array of diffractive optical MEMS devices (micro-electro-mechanical system devices) can also be used in a corresponding manner. In one example, a diffractive optical MEMS device is composed of a plurality of reflective ribbons that can be deformed relative to one another to form a grating that reflects incident light as diffracted light.

A further alternative example of a programmable mirror array employs a matrix arrangement of tiny mirrors, each of which can be individually tilted about an axis by applying a suitable localized electric field, or by employing piezoelectric actuation means. Once again, the mirrors are matrix-addressable, such that addressed mirrors reflect an incoming radiation beam in a different direction than unaddressed mirrors; in this manner, the reflected beam can be patterned according to the addressing pattern of the matrix-addressable mirrors. The required matrix addressing can be performed using suitable electronic means.

Another example PD is a programmable LCD array.

The lithographic apparatus can comprise one or more contrast devices. For example, it can have a plurality of arrays of individually controllable elements, each controlled independently of each other. In such an arrangement, some or all of the arrays of individually controllable elements can have at least one of a common illumination system (or part of an illumination system), a common support structure for the arrays of individually controllable elements, and/or a common projection system (or part of the projection system).

In one example, such as the embodiment depicted in FIG. 1, the substrate W has a substantially circular shape, optionally with a notch and/or a flattened edge along part of its perimeter. In another example, the substrate has a polygonal shape, e.g., a rectangular shape.

Examples where the substrate has a substantially circular shape include examples where the substrate has a diameter of at least 25 mm, at least 50 mm, at least 75 mm, at least 100 mm, at least 125 mm, at least 150 mm, at least 175 mm, at least 200 mm, at least 250 mm, or at least 300 mm. Alternatively, the substrate has a diameter of at most 500 mm, at most 400 mm, at most 350 mm, at most 300 mm, at most 250 mm, at most 200 mm, at most 150 mm, at most 100 mm, or at most 75 mm.

Examples where the substrate is polygonal, e.g., rectangular, include examples where at least one side, at least 2 sides or at least 3 sides, of the substrate has a length of at least 5 cm, at least 25 cm, at least 50 cm, at least 100 cm, at least 150 cm, at least 200 cm, or at least 250 cm.

At least one side of the substrate has a length of at most 1000 cm, at most 750 cm, at most 500 cm, at most 350 cm, at most 250 cm, at most 150 cm, or at most 75 cm.

In one example, the substrate W is a wafer, for instance a semiconductor wafer. The wafer material can be selected from the group consisting of Si, SiGe, SiGeC, SiC, Ge, GaAs, InP, and InAs. The wafer can be: a III/V compound semiconductor wafer, a silicon wafer, a ceramic substrate, a glass substrate, or a plastic substrate. The substrate can be transparent (for the naked human eye), colored, or absent a color.

The thickness of the substrate can vary and, to an extent, can depend on the substrate material and/or the substrate dimensions. The thickness can be at least 50 μm, at least 100 μm, at least 200 μm, at least 300 μm, at least 400 μm, at least 500 μm, or at least 600 μm. Alternatively, the thickness of the substrate can be at most 5000 μm, at most 3500 μm, at most 2500 μm, at most 1750 μm, at most 1250 μm, at most 1000 μm, at most 800 μm, at most 600 μm, at most 500 μm, at most 400 μm, or at most 300 μm.

The substrate referred to herein can be processed, before or after exposure, in for example a track (a tool that typically applies a layer of resist to a substrate and develops the exposed resist), a metrology tool, and/or an inspection tool. In one example, a resist layer is provided on the substrate.

The projection system can image the pattern on the array of individually controllable elements, such that the pattern is coherently formed on the substrate. Alternatively, the projection system can image secondary sources for which the elements of the array of individually controllable elements act as shutters. In this respect, the projection system can comprise an array of focusing elements such as a micro lens array (known as an MLA) or a Fresnel lens array to form the secondary sources and to image spots onto the substrate. The array of focusing elements (e.g., MLA) comprises at least 10 focus elements, at least 100 focus elements, at least 1,000 focus elements, at least 10,000 focus elements, at least 100,000 focus elements, or at least 1,000,000 focus elements.

The number of individually controllable elements in the patterning device is equal to or greater than the number of focusing elements in the array of focusing elements. One or more (e.g., 1,000 or more, the majority, or each) of the focusing elements in the array of focusing elements can be optically associated with one or more of the individually controllable elements in the array of individually controllable elements, with 2 or more, 3 or more, 5 or more, 10 or more, 20 or more, 25 or more, 35 or more, or 50 or more of the individually controllable elements in the array of individually controllable elements.

The MLA can be movable (e.g., with the use of one or more actuators) at least in the direction to and away from the substrate. Being able to move the MLA to and away from the substrate allows, e.g., for focus adjustment without having to move the substrate.

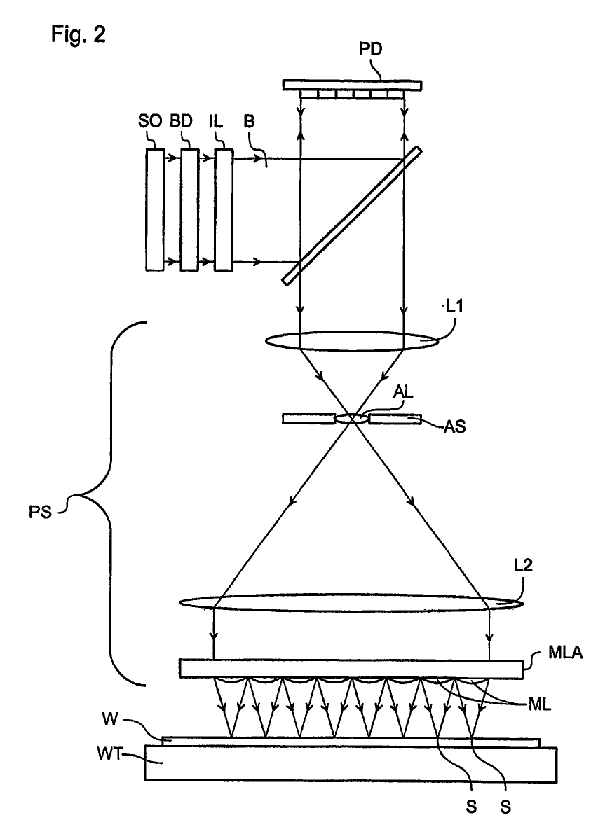

As herein depicted in FIGS. 1 and 2, the apparatus is of a reflective type (e.g., employing a reflective array of individually controllable elements). Alternatively, the apparatus can be of a transmission type (e.g., employing a transmission array of individually controllable elements).

The lithographic apparatus can be of a type having two (dual stage) or more substrate tables. In such “multiple stage” machines, the additional tables can be used in parallel, or preparatory steps can be carried out on one or more tables while one or more other tables are being used for exposure. The lithographic apparatus can also be of a type wherein at least a portion of the substrate can be covered by an “immersion liquid” having a relatively high refractive index, e.g., water, so as to fill a space between the projection system and the substrate. An immersion liquid can also be applied to other spaces in the lithographic apparatus, for example, between the patterning device and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring again to FIG. 1, the illuminator IL receives a radiation beam from a radiation source SO. The radiation source provides radiation having a wavelength of at least 5 nm, at least 10 nm, at least 11-13 nm, at least 50 nm, at least 100 nm, at least 150 nm, at least 175 nm, at least 200 nm, at least 250 nm, at least 275 nm, at least 300 nm, at least 325 nm, at least 350 nm, or at least 360 nm. Alternatively, the radiation provided by radiation source SO has a wavelength of at most 450 nm, at most 425 nm, at most 375 nm, at most 360 nm, at most 325 nm, at most 275 nm, at most 250 nm, at most 225 nm, at most 200 nm, or at most 175 nm. The radiation can have a wavelength including 436 nm, 405 nm, 365 nm, 355 nm, 248 nm, 193 nm, 157 nm, and/or 126 nm.

The source and the lithographic apparatus can be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source can be an integral part of the lithographic apparatus, for example when the source is a mercury lamp. The source SO and the illuminator IL, together with the beam delivery system BD if required, can be referred to as a radiation system.

The illuminator IL, can comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL can comprise various other components, such as an integrator IN and a condenser CO. The illuminator can be used to condition the radiation beam to have a desired uniformity and intensity distribution in its cross-section. The illuminator IL, or an additional component associated with it, can also be arranged to divide the radiation beam into a plurality of sub-beams that can, for example, each be associated with one or a plurality of the individually controllable elements of the array of individually controllable elements. A two-dimensional diffraction grating can, for example, be used to divide the radiation beam into sub-beams. In the present description, the terms “beam of radiation” and “radiation beam” encompass, but are not limited to, the situation in which the beam is comprised of a plurality of such sub-beams of radiation.

The radiation beam B is incident on the patterning device PD (e.g., an array of individually controllable elements) and is modulated by the patterning device. Having been reflected by the patterning device PD, the radiation beam B passes through the projection system PS, which focuses the beam onto a target portion C of the substrate W. With the aid of the positioner PW and position sensor IF2 (e.g., an interferometric device, linear encoder, capacitive sensor, or the like), the substrate table WT can be moved accurately, e.g., so as to position different target portions C in the path of the radiation beam B. Where used, the positioning means for the array of individually controllable elements can be used to correct accurately the position of the patterning device PD with respect to the path of the beam B, e.g., during a scan.

In one example, movement of the substrate table WT is realized with the aid of a long-stroke module (course positioning) and a short-stroke module (fine positioning), which are not explicitly depicted in FIG. 1. In another example, a short stroke stage cannot be present. A similar system can also be used to position the array of individually controllable elements. It will be appreciated that the beam B can alternatively/additionally be moveable, while the object table and/or the array of individually controllable elements can have a fixed position to provide the required relative movement. Such an arrangement can assist in limiting the size of the apparatus. As a further alternative, which can, e.g., be applicable in the manufacture of flat panel displays, the position of the substrate table WT and the projection system PS can be fixed and the substrate W can be arranged to be moved relative to the substrate table WT. For example, the substrate table WT can be provided with a system for scanning the substrate W across it at a substantially constant velocity.

As shown in FIG. 1, the beam of radiation B can be directed to the patterning device PD by means of a beam splitter BS configured such that the radiation is initially reflected by the beam splitter and directed to the patterning device PD. It should be realized that the beam of radiation B can also be directed at the patterning device without the use of a beam splitter. The beam of radiation can be directed at the patterning device at an angle between 0 and 90°, between 5 and 85°, between 15 and 75°, between 25 and 65°, or between 35 and 55° (the embodiment shown in FIG. 1 is at a 90° angle). The patterning device PD modulates the beam of radiation B and reflects it back to the beam splitter BS which transmits the modulated beam to the projection system PS. It will be appreciated, however, that alternative arrangements can be used to direct the beam of radiation B to the patterning device PD and subsequently to the projection system PS. In particular, an arrangement such as is shown in FIG. 1 cannot be required if a transmission patterning device is used.

The depicted apparatus can be used in several modes:

1. In step mode, the array of individually controllable elements and the substrate are kept essentially stationary, while an entire pattern imparted to the radiation beam is projected onto a target portion C at one go (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the array of individually controllable elements and the substrate are scanned synchronously while a pattern imparted to the radiation beam is projected onto a target portion C (i.e., a single dynamic exposure). The velocity and direction of the substrate relative to the array of individually controllable elements can be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In pulse mode, the array of individually controllable elements is kept essentially stationary and the entire pattern is projected onto a target portion C of the substrate W using a pulsed radiation source. The substrate table WT is moved with an essentially constant speed such that the beam B is caused to scan a line across the substrate W. The pattern on the array of individually controllable elements is updated as required between pulses of the radiation system and the pulses are timed such that successive target portions C are exposed at the required locations on the substrate W. Consequently, the beam B can scan across the substrate W to expose the complete pattern for a strip of the substrate. The process is repeated until the complete substrate W has been exposed line by line.

4. Continuous scan mode is essentially the same as pulse mode except that the substrate W is scanned relative to the modulated beam of radiation B at a substantially constant speed and the pattern on the array of individually controllable elements is updated as the beam B scans across the substrate W and exposes it. A substantially constant radiation source or a pulsed radiation source, synchronized to the updating of the pattern on the array of individually controllable elements, can be used.

5. In pixel grid imaging mode, which can be performed using the lithographic apparatus of FIG. 2, the pattern formed on substrate W is realized by subsequent exposure of spots formed by a spot generator that are directed onto patterning device PD. The exposed spots have substantially the same shape. On substrate W the spots are printed in substantially a grid. In one example, the spot size is larger than a pitch of a printed pixel grid, but much smaller than the exposure spot grid. By varying intensity of the spots printed, a pattern is realized. In between the exposure flashes the intensity distribution over the spots is varied.

Combinations and/or variations on the above described modes of use or entirely different modes of use can also be employed.

In lithography, a pattern is exposed on a layer of resist on the substrate. The resist is then developed. Subsequently, additional processing steps are performed on the substrate. The effect of these subsequent processing steps on each portion of the substrate depends on the exposure of the resist. In particular, the processes are tuned such that portions of the substrate that receive a radiation dose above a given dose threshold respond differently to portions of the substrate that receive a radiation dose below the dose threshold. For example, in an etching process, areas of the substrate that receive a radiation dose above the threshold are protected from etching by a layer of developed resist. However, in the post-exposure development, the portions of the resist that receive a radiation dose below the threshold are removed and therefore those areas are not protected from etching. Accordingly, a desired pattern can be etched. In particular, the individually controllable elements in the patterning device are set such that the radiation that is transmitted to an area on the substrate within a pattern feature is at a sufficiently high intensity that the area receives a dose of radiation above the dose threshold during the exposure. The remaining areas on the substrate receive a radiation dose below the dose threshold by setting the corresponding individually controllable elements to provide a zero or significantly lower radiation intensity.

In practice, the radiation dose at the edges of a pattern feature does not abruptly change from a given maximum dose to zero dose even if the individually controllable elements are set to provide the maximum radiation intensity on one side of the feature boundary and the minimum radiation intensity on the other side. Instead, due to diffractive effects, the level of the radiation dose drops off across a transition zone. The position of the boundary of the pattern feature ultimately formed by the developed resist is determined by the position at which the received dose drops below the radiation dose threshold. The profile of the drop-off of radiation dose across the transition zone, and hence the precise position of the pattern feature boundary, can be controlled more precisely by setting the individually controllable elements that provide radiation to points on the substrate that are on or near the pattern feature boundary. These can be not only to maximum or minimum intensity levels, but also to intensity levels between the maximum and minimum intensity levels. This is commonly referred to as “grayscaling.”

Grayscaling provides greater control of the position of the pattern feature boundaries than is possible in a lithography system in which the radiation intensity provided to the substrate by a given individually controllable element can only be set to two values (e.g., just a maximum value and a minimum value). At least 3, at least 4 radiation intensity values, at least 8 radiation intensity values, at least 16 radiation intensity values, at least 32 radiation intensity values, at least 64 radiation intensity values, at least 128 radiation intensity values, or at least 256 different radiation intensity values can be projected onto the substrate.

It should be appreciated that grayscaling can be used for additional or alternative purposes to that described above. For example, the processing of the substrate after the exposure can be tuned, such that there are more than two potential responses of regions of the substrate, dependent on received radiation dose level. For example, a portion of the substrate receiving a radiation dose below a first threshold responds in a first manner; a portion of the substrate receiving a radiation dose above the first threshold but below a second threshold responds in a second manner; and a portion of the substrate receiving a radiation dose above the second threshold responds in a third manner. Accordingly, grayscaling can be used to provide a radiation dose profile across the substrate having more than two desired dose levels. The radiation dose profile can have at least 2 desired dose levels, at least 3 desired radiation dose levels, at least 4 desired radiation dose levels, at least 6 desired radiation dose levels or at least 8 desired radiation dose levels.

It should further be appreciated that the radiation dose profile can be controlled by methods other than by merely controlling the intensity of the radiation received at each point on the substrate, as described above. For example, the radiation dose received by each point on the substrate can alternatively or additionally be controlled by controlling the duration of the exposure of the point. As a further example, each point on the substrate can potentially receive radiation in a plurality of successive exposures. The radiation dose received by each point can, therefore, be alternatively or additionally controlled by exposing the point using a selected subset of the plurality of successive exposures.

FIG. 2 depicts an arrangement of the apparatus according to the present invention that can be used, e.g., in the manufacture of flat panel displays. Components corresponding to those shown in FIG. 1 are depicted with the same reference numerals. Also, the above descriptions of the various embodiments, e.g., the various configurations of the substrate, the contrast device, the MLA, the beam of radiation, etc., remain applicable.

As shown in FIG. 2, the projection system PS includes a beam expander, which comprises two lenses L1, L2. The first lens L1 is arranged to receive the modulated radiation beam B and focus it through an aperture in an aperture stop AS. A further lens AL can be located in the aperture. The radiation beam B then diverges and is focused by the second lens L2 (e.g., a field lens).

The projection system PS further comprises an array of lenses MLA arranged to receive the expanded modulated radiation B. Different portions of the modulated radiation beam B, corresponding to one or more of the individually controllable elements in the patterning device PD, pass through respective different lenses ML in the array of lenses MLA. Each lens focuses the respective portion of the modulated radiation beam B to a point which lies on the substrate W. In this way an array of radiation spots S is exposed onto the substrate W. It will be appreciated that, although only eight lenses of the illustrated array of lenses 14 are shown, the array of lenses can comprise many thousands of lenses (the same is true of the array of individually controllable elements used as the patterning device PD).

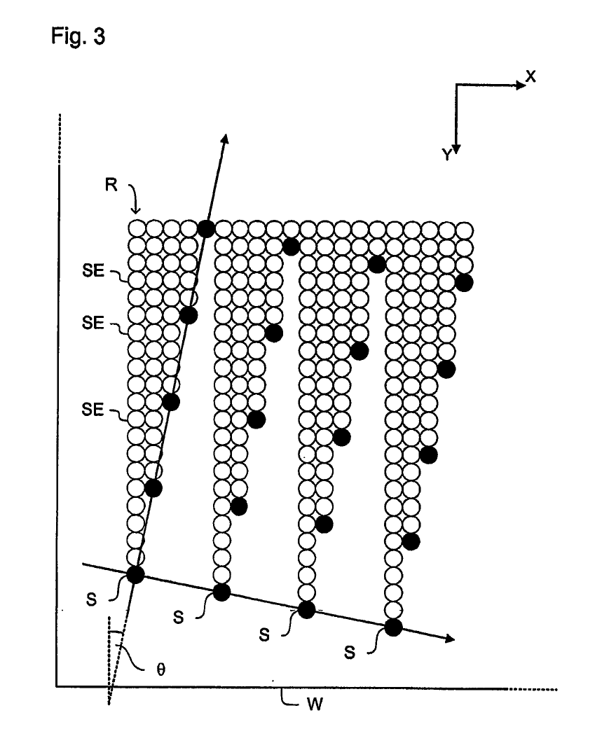

FIG. 3 illustrates schematically how a pattern on a substrate W is generated using the system of FIG. 2, according to one embodiment of the present invention. The filled in circles represent the array of spots S projected onto the substrate W by the array of lenses MLA in the projection system PS. The substrate W is moved relative to the projection system PS in the Y direction as a series of exposures are exposed on the substrate W. The open circles represent spot exposures SE that have previously been exposed on the substrate W. As shown, each spot projected onto the substrate by the array of lenses within the projection system PS exposes a row R of spot exposures on the substrate W. The complete pattern for the substrate is generated by the sum of all the rows R of spot exposures SE exposed by each of the spots S. Such an arrangement is commonly referred to as “pixel grid imaging,” discussed above.

It can be seen that the array of radiation spots S is arranged at an angle relative to the substrate W (the edges of the substrate lie parallel to the X and Y directions). This is done so that when the substrate is moved in the scanning direction (the Y-direction), each radiation spot will pass over a different area of the substrate, thereby allowing the entire substrate to be covered by the array of radiation spots 15. The angle θ can be at most 20°, at most 10°, at most 5°, at most 3°, at most 1°, at most 0.5°, at most 0.25°, at most 0.10°, at most 0.05°, or at most 0.01°. Alternatively, the angle θ is at least 0.001°.

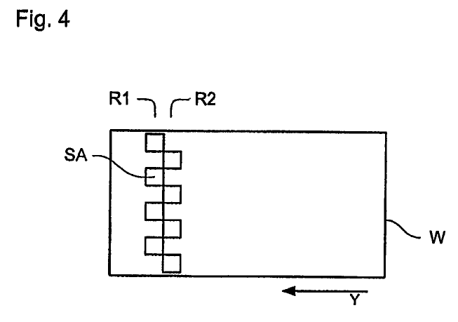

FIG. 4 shows schematically how an entire flat panel display substrate W can be exposed in a single scan using a plurality of optical engines, according to one embodiment of the present invention. In the example shown eight arrays SA of radiation spots S are produced by eight optical engines (not shown), arranged in two rows R1, R2 in a “chess board” configuration, such that the edge of one array of radiation spots (e.g., spots S in FIG. 3) slightly overlaps (in the scanning direction Y) with the edge of the adjacent array of radiation spots. In one example, the optical engines are arranged in at least 3 rows, for instance 4 rows or 5 rows. In this way, a band of radiation extends across the width of the substrate W, allowing exposure of the entire substrate to be performed in a single scan. It will be appreciated that any suitable number of optical engines can be used. In one example, the number of optical engines is at least 1, at least 2, at least 4, at least 8, at least 10, at least 12, at least 14, or at least 17. Alternatively, the number of optical engines is less than 40, less than 30 or less than 20.

Each optical engine can comprise a separate illumination system IL, patterning device PD and projection system PS as described above. It is to be appreciated, however, that two or more optical engines can share at least a part of one or more of the illumination system, patterning device and projection system.

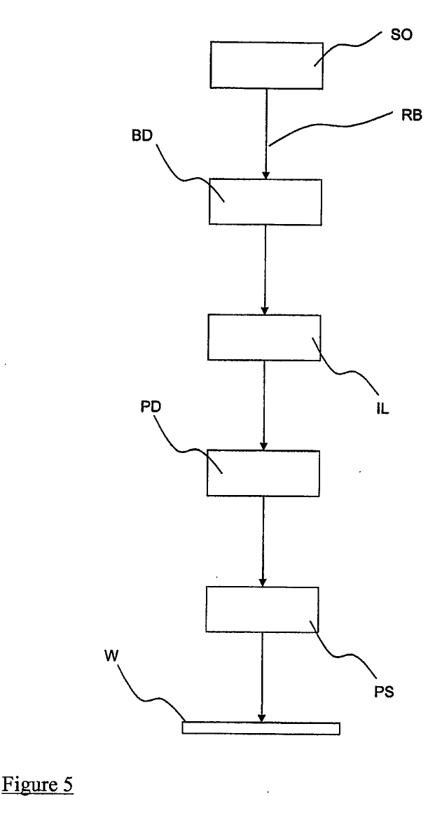

FIG. 5 is a simplified description of the lithographic apparatus depicted in FIG. 1. In FIG. 5, a radiation source SO emits a radiation beam RB, which subsequently passes through a beam delivery system BD. The radiation beam RB then passes onto and through an illuminator IL and onto a patterning device PD. The radiation beam RB is patterned by the patterning device PD (e.g. a pattern is imparted into the cross-section of the radiation beam RB), and the patterned radiation beam RB is then projected onto a substrate W by a projection system PS.

In one embodiment, the projection system PS may introduce a reduction factor in the radiation beam RB. In such a case, the pattern (or patterns) projected onto the substrate W by the projection system PS may be a few times smaller, tens of times smaller, or hundreds of times smaller that of the patterning device PD that patterns the radiation beam RB.

It may be desirable to determine the uniformity of elements of a lithographic apparatus, such as that depicted in FIG. 5, and more generally, it may be desirable to determine the uniformity of illumination of the substrate by the radiation beam RB. Information indicative of the uniformity of various elements of the lithographic apparatus may be obtained by determining a uniformity of a radiation beam that has come into contact with (e.g. passed through or reflected off) one or more of these elements.

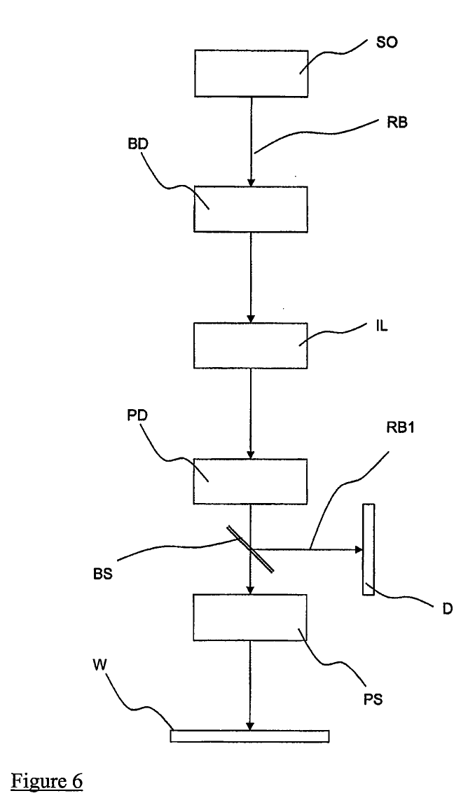

FIG. 6 depicts an exemplary apparatus that obtains information indicative of the uniformity of elements of the lithographic apparatus. In FIG. 6, a source SO emits a radiation beam RB, which passes through the beam delivery system BD and the illuminator IL before falling incident upon the patterning device PD. After the radiation beam RB has been patterned by the patterning device PD, it subsequently falls incident upon a beam splitter BS. The beam splitter BS is configured to direct a small portion of the radiation beam RB1 towards a detector D, while allowing the remaining portion of the radiation beam RB (with the exception of any losses in transmission) to pass to the projection system PS. The projection system PS subsequently projects the radiation beam RB onto the substrate W.

The detector D may be used to determine various properties of the small portion of the radiation beam RB1. For example, an intensity distribution (or changes in the intensity distribution) or an angular intensity distribution (or changes in the angular intensity distribution) of the small portion of the radiation beam RB1 may be measured by the detector D. In additional embodiments, a polarization (or changes in the polarization) of the small portion of the radiation beam RB1 or a pupil shape or mode (or changes in the pupil shape or mode) of the small portion of the radiation beam RB1 may be determined by the detector D. Further, an optical element, such as a lens, may be positioned between the beam splitter BS and detector D to detect the pupil shape or mode (or changes in the pupil shape or mode).

The beam splitter BS and/or detector D maybe moveable such that only a specific part of the small portion of the radiation beam RB1 is investigated (e.g. imaged, detected, etc.) at any one time. In one embodiment, the beam splitter BS and/or detector D may be moved such that a part of the small portion of the radiation beam RB1 that reflects off or passes through a certain part of the patterning device PD is imaged by the PD. For example, this specific part of the patterning device PD could be one or more individually controllable elements, such as inividually-controllable mirrors of the patterning device PD.

In FIG. 6, the small portion of the radiation beam RB1, which is reflected towards the detector D, has passed through the beam delivery system BD and illuminator IL and has passed through or has been reflected off the patterning device PD. Therefore, the small portion of the radiation beam RB1 may be investigated to obtain information indicative of the uniformity of the beam delivery system BD, the illuminator IL, and the patterning device PD. However, as the radiation beam has not passed through the projection system PS, information regarding the uniformity of the projection system cannot be obtained using the apparatus depicted in FIG. 6.

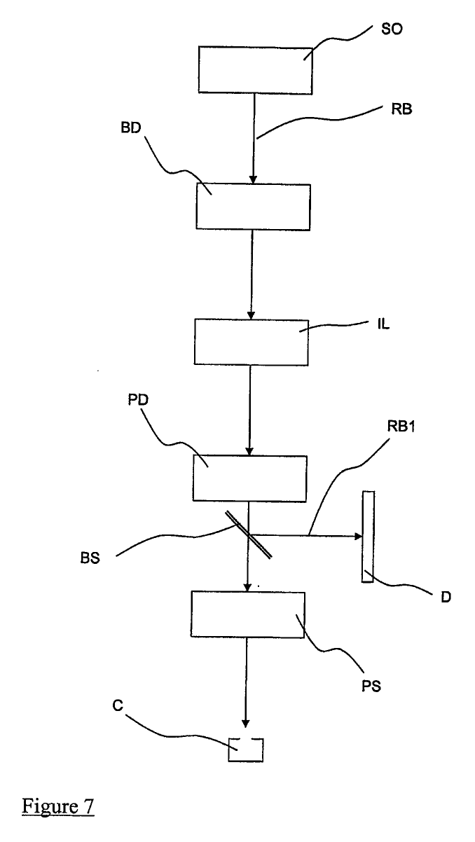

FIG. 7 depicts an exemplary lithographic apparatus that obtains information indicative of the uniformity of the projection system PS. In FIG. 7, a pin-hole type camera device C is positioned downstream of the projection system PS and in the optical path of the radiation beam RB, thus allowing information indicative of the uniformity of the projection system PS to be derived from properties of the radiation beam RB. Further, in additional embodiments, the pin-hole type camera device C may be moveable in relation to the radiation beam RB such that different parts of the radiation beam RB may be investigated.

In the embodiment of FIG. 7, information indicative of the uniformity of the projection system PS is obtained from the radiation beam RB after it has passed through the projection system PS. As the projection system may introduce a reduction factor, patterns in the radiation beam RB may be a few times smaller, tens of times smaller, or hundreds of times smaller than corresponding patterns in the radiation beam prior to passing through the projection system PS. Therefore, it may difficult or impossible to obtain clear, accurate, and high-resolution information regarding the uniformity of the projection system PS from a radiation beam RB that has already passed through the projection system PS.

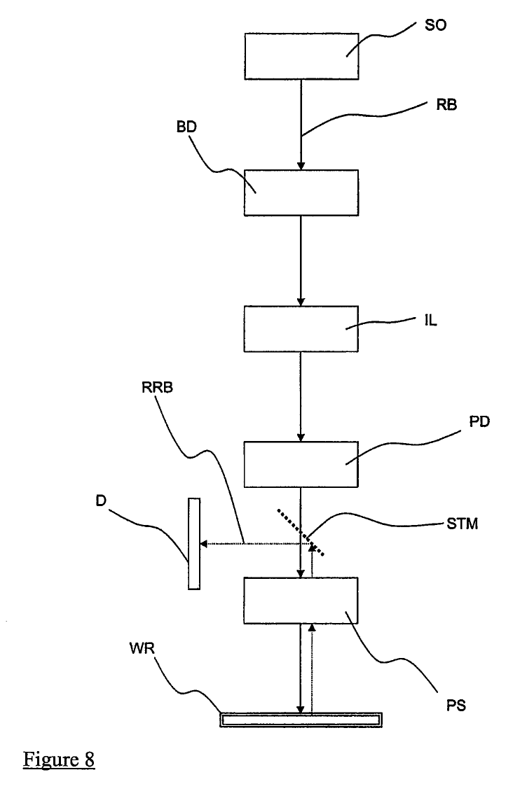

FIG. 8 depicts a second exemplary lithographic apparatus that obtains information indicative of the uniformity of the projection system PS. In FIG. 8, a source SO emits a radiation beam RB, which passes through a beam delivery system BD and an illuminator IL. The radiation beam RB is subsequently patterned by a patterning device PD before entering a projection system PS. The projection system PS projects the patterned radiation beam RB onto a substrate (not shown) in order to apply a pattern to the substrate. In contrast to the exemplary apparatus of FIGS. 6 and 7, the exemplary apparatus of FIG. 8 comprises a detector D and a semi-transparent mirror S™, and the detector D and the semi-transparent mirror S™ may be used to obtain information indicating a uniformity of the projection system PS.

In one embodiment, detector D and semi-transparent mirror S™ are located along a path of the radiaton beam BM and substantially between the patterning device PD and the projection system PS. In additional embodiments, the radiation beam RB need not pass directly between the patterning device PD and projection system PS, but instead may be directed by one or more mirrors, lenses, or similar optical elements between the patterning device PD and projection system PS. In such an embodiment, the detector D and semi-transparent mirror S™ may be positioned at any point along the path of the radiation beam RB that passes between the patterning device PD and the projection system PS.

In FIG. 8, the substrate is provided with a reflective surface WR, which, together with the semi-transparent mirror S™ and detector D, may be used to obtain information indicative of the uniformity of the projection system PS. In FIG. 8, the radiation beam RB is patterned by the patterning device PD, and is directed through the semi-transparent mirror S™ and towards the projection system PS. The projection system PS projects the radiation beam onto the substrate provided with a reflective surface WR. The reflective surface WR then reflects the radiation beam RB back into and through the projection system PS. The reflected radiation beam RRB subsequently falls incident upon a mirrored surface of the semi-transparent mirror S™, which directs the reflected radiation beam RRB towards the detector D.

Information indicative of the uniformity of the projection system PS may be obtained by investigating properties of the reflected radiation beam RRB using the detector D. For example, an intensity distribution (or changes in the intensity distribution or an angular intensity distribution (or changes in the angular intensity distribution) of the reflected radiation beam RRB can be measured by the detector D. Alternatively or additionally, a polarization (or a change in the polarization) of the reflected radiation beam RRB, or a pupil shape or mode (or a change in the pupil shape or mode) of the reflected radiation beam RRB may be determined by the detector D. Further, in additional embodiments, a lens may be positioned between the beam splitter BS and detector D to detect the pupil shape or mode (or the change in the pupil shape or mode).

The apparatus depicted in FIG. 8 possesses certain advantages over the exemplary apparatus depicted in FIG. 7. As described above, the projection system PS may apply a reduction factor to the radiation beam RB when the radiation beam RB passes through the projection system PS. However, when the radiation beam RRB is reflected off the reflective surface WR and passed back through the projection system PS, a magnification factor is applied to the radiation beam RRB that is equivalent to the inverse of the reduction factor previously applied to the radiation beam RRB. As such, the reflected radiation beam RRB is detected and investigated without any associated reduction factor, and therefore, a clear and high resolution determination of properties of the reflected radiation beam RRB may be obtained. Furthermore, since the radiation beam RB passes through the projection system PS twice before its properties are investigated using the detector D, any uniformities in the projection system PS are imparted into the radiation beam RB twice. This effect improves the signal to noise ratio of the detection process, thereby improving the detection of properties of the radiation beam RB affected by the projection system PS.

In FIG. 8, the reflected radiation beam RRB is also affected by the uniformity of the beam delivery system BD, illuminator IL, and patterning device PD. Therefore, in additional embodiments, the apparatus depicted in FIG. 8 may be used to obtain information indicative of the uniformity of all elements of the lithographic apparatus through which the radiation beam RB passes or off which the radiation beam RB is reflected.

Further, in additional embodiments, the apparatus of FIG. 7 may be used in conjunction with the apparatus of FIG. 8 to obtain clearer indications of the uniformity of the projection system PS. For example, the apparatus of FIG. 8 may be used to obtain information indicative of the uniformities of the beam delivery system BD, illuminator IL, patterning device PD, and projection system PS. Additionally, the apparatus of FIG. 7 may be used to obtain information indicative of the uniformity of the beam delivery system BD, illuminator IL, and patterning device PD. The information obtained using the apparatus of FIG. 8 may be then be taken away from or compared with the information obtained using the apparatus of FIG. 7, thereby generating (or at least clarifying) information indicative of the uniformity of the projection system PS. The apparatus of FIGS. 7 and 8 may be used simultaneously, or in additional embodiments, these apparatus may be selectively moveable into and out of the path of the radiation beam RB such that the apparatus are useable independently.

The embodiment of FIG. 8 comprises a substrate provided with a reflective surface WR. However, in additional embodiments, the reflective surface may take the form of a mirror or any other reflective surface that would be apparent to one skilled in the arts. Further, one skilled in the art would recognize that the reflective surface could be held in place on a substrate table, such as the exemplary substrate table of FIG. 1, or could be part of the substrate table without departing from the spirit or scope of the present invention.

In an additional embodiment, an apparatus for obtaining information indicative of the uniformity of a projection system of a lithographic apparatus comprises a first directing apparatus. The first directing apparatus may be arranged to direct an electromagnetic radiation beam toward a projection system such that the electromagnetic radiation beam passes from a first end of the projection system through to a second end of the projection system. Examples of the first directing apparatus include, but are not limited to, a patterning device, a mirror, and a lens.

The apparatus also comprises a second directing apparatus arranged to direct the electromagnetic radiation beam that has passed through the projection system back toward the projection system, such that the electromagnetic radiation beam passes from the second end of the projection system through to the first end of the projection system. Examples of the second directing apparatus include, but are not limited to, a reflective surface, a substrate provided with a reflective surface, or a substrate table or holder provided with a reflective surface.

In such an embodiment, any reduction factor that was introduced when the radiation beam passed one way through the projection system is removed by introducing a magnification factor (i.e., the inverse of the reduction factor) when the radiation beam travels back through the projection system in the opposite direction.

Further, the apparatus may comprise a detector arranged to detect at least a part of the electromagnetic radiation beam after the electromagnetic radiation beam has passed back through the projection system to obtain information indicative of the uniformity of the projection system. The apparatus may also comprise a third directing apparatus that directs the electromagnetic radiation beam to the detector after the radiation beam has passed back through the projection system. The third directing apparatus may comprise a first surface and a second surface, the first surface being arranged to transmit the electromagnetic radiation beam and the second surface being arranged to reflect to the radiation beam. In one embodiment, the third directing apparatus may comprise a semi-transparent mirror.

In additional embodiments, the third directing apparatus may be positioned and configured such that the electromagnetic radiation beam to pass through the third directing apparatus before passing from the first end of the projection system to the second end of the projection system. The third directing apparatus may additionally reflect the electromagnetic radiation beam after the electromagnetic radiation beam has passed from the second end of the projection system through to the first end of the projection system.

Further, the third directing apparatus may be moveable into and out of a path of the radiation beam. For example, the third directing apparatus maybe moveable out of a path of the radiation beam when it is not necessary or desirable to obtain information indicative of the uniformity of the projection system (e.g., when patterns are being applied to the substrate). The third directing apparatus may also be moveable into a path of the radiation beam when it is necessary or desirable to obtain information indicative of the uniformity of the projection system (e.g., when patterns are not being applied to the substrate). Furthermore, the third directing apparatus may be located, or may be locatable, at a position coincident with a path of the radiation beam between a patterning device and the projection system.

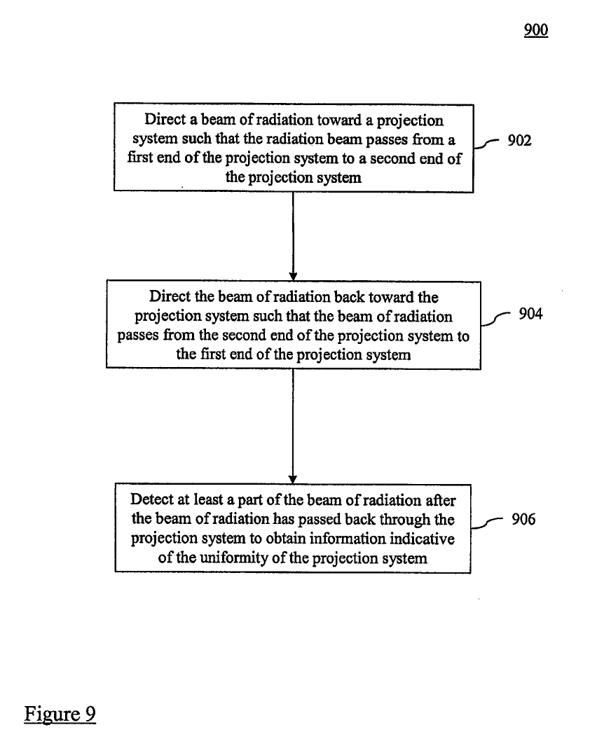

FIG. 9 depicts an exemplary method 900 for obtaining information indicative of the uniformity of elements of a lithographic apparatus. In step 902, a beam of radiation is directed toward a projection system such that the radiation beam passes from a first end of the projection system to a second end of the projection system. In one embodiment, an optical element, including, but not limited to, a patterning device, a mirror, or a lens may direct the beam of radiation beam toward the projection system in step 902.

In step 904, the beam of radiation (that has passed through the projection system) is subsequently directed back toward the projection system such that the beam of radiation passes from the second end of the projection system to the first end of the projection system. In one embodiment, the beam of radiation is directed back toward the projection system using a reflective surface, including, but not limited to a substrate provided with a reflective surface, a substrate table provided with a reflective surface, or a substrate holder provided with a reflective surface. Further, in additional embodiments, the beam of radiation is directed to a detector after the radiation beam has passed back through the projection system using a beam directing apparatus, such as, but not limited to a semi-transparent mirror.

In step 906, at least a part of the beam of radiation is detected after the beam of radiation has passed back through the projection system to obtain information indicative of the uniformity of the projection system

The apparatus and methods described herein obtain information indicative of the uniformity of a projection system of a lithographic apparatus. This information may be derived directly or indirectly from a detected radiation beam. For example, the information can be obtained or derived from at least one of a field uniformity of the at least a part of the electromagnetic radiation beam; a change in the field uniformity of the at least a part of the electromagnetic radiation beam; and a pupil uniformity of the at least a part of the electromagnetic radiation beam; or (iv) a change in the pupil uniformity of the at least a part of the electromagnetic radiation beam.

More specifically, information can be obtained or derived from, for example, at least one of an intensity distribution of the at least a part of the electromagnetic radiation beam; a change in the intensity distribution of the at least a part of the electromagnetic radiation beam; an angular intensity distribution of the at least a part of the electromagnetic radiation beam; a change in the angular intensity distribution of the at least a part of the electromagnetic radiation beam; a polarization of the at least a part of the electromagnetic radiation beam; a change in the polarization of the at least a part of the electromagnetic radiation beam; a pupil shape or mode of the at least a part of the electromagnetic radiation beam; or a change in the pupil shape or mode of the at least a part of the electromagnetic radiation beam.

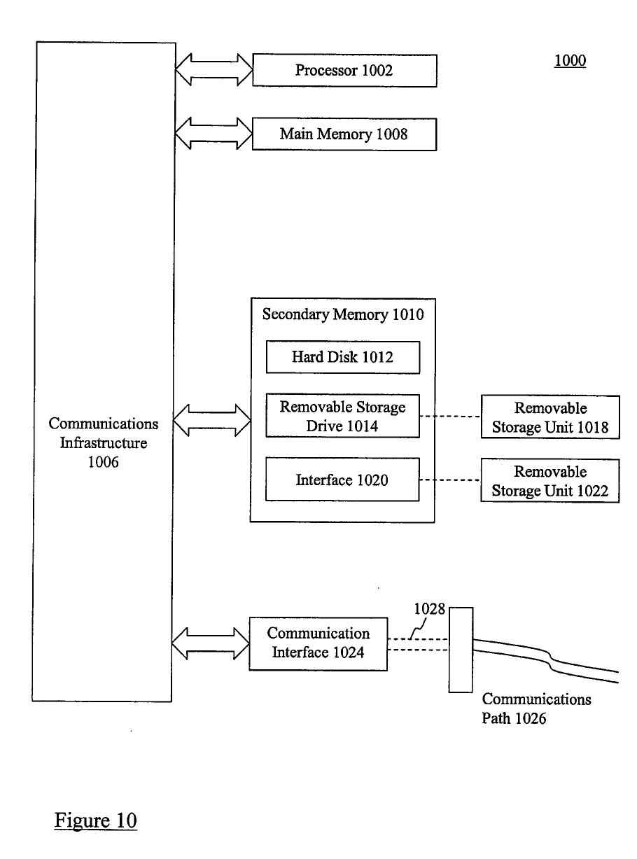

FIG. 10 depicts an exemplary computer system 1000 upon which the present invention may be implemented. The exemplary computer system 1000 includes one or more processors, such as processor 1002. The processor 1002 is connected to a communication infrastructure 1006, such as a bus or network. Various software implementations are described in terms of this exemplary computer system. After reading this description, it will become apparent to a person skilled in the relevant art how to implement the invention using other computer systems and/or computer architectures.

Computer system 1000 also includes a main memory 1008, preferably random access memory (RAM), and may include a secondary memory 1010. The secondary memory 1010 may include, for example, a hard disk drive 1012 and/or a removable storage drive 1014, representing a magnetic tape drive, an optical disk drive, etc. The removable storage drive 1014 reads from and/or writes to a removable storage unit 1018 in a well-known manner. Removable storage unit 1018 represents a magnetic tape, optical disk, or other storage medium that is read by and written to by removable storage drive 1014. As will be appreciated, the removable storage unit 1018 can include a computer usable storage medium having stored therein computer software and/or data.

In alternative implementations, secondary memory 1010 may include other means for allowing computer programs or other instructions to be loaded into computer system 1000. Such means may include, for example, a removable storage unit 1022 and an interface 1020. An example of such means may include a removable memory chip (such as an EPROM, or PROM) and associated socket, or other removable storage units 1022 and interfaces 1020, which allow software and data to be transferred from the removable storage unit 1022 to computer system 1000.

Computer system 1000 may also include one or more communications interfaces, such as communications interface 1024. Communications interface 1024 allows software and data to be transferred between computer system 1000 and external devices. Examples of communications interface 1024 may include a modem, a network interface (such as an Ethernet card), a communications port, a PCMCIA slot and card, etc. Software and data transferred via communications interface 1024 are in the form of signals 1028, which may be electronic, electromagnetic, optical or other signals capable of being received by communications interface 1024. These signals 1028 are provided to communications interface 1024 via a communications path (i.e., channel) 1026. This channel 1026 carries signals 1028 and may be implemented using wire or cable, fiber optics, an RF link and other communications channels. In an embodiment of the invention, signals 1028 include data packets sent to processor 1002. Information representing processed packets can also be sent in the form of signals 1028 from processor 1002 through communications path 1026.

The terms “computer program medium” and “computer usable medium” are used to refer generally to media such as removable storage units 1018 and 1022, a hard disk installed in hard disk drive 1012, and signals 1028, which provide software to the computer system 1000.

Computer programs are stored in main memory 1008 and/or secondary memory 1010. Computer programs may also be received via communications interface 1024. Such computer programs, when executed, enable the computer system 1000 to implement the present invention as discussed herein. In particular, the computer programs, when executed, enable the processor 1002 to implement the present invention. Where the invention is implemented using software, the software may be stored in a computer program product and loaded into computer system 1000 using removable storage drive 1018, hard drive 1012 or communications interface 1024.

Although specific reference may be made in this text to the use of lithographic apparatus in the manufacture of a specific device (e.g. an integrated circuit or a flat panel display), it should be understood that the lithographic apparatus described herein may have other applications. Applications include, but are not limited to, the manufacture of integrated circuits, integrated optical systems, guidance and detection patterns for magnetic domain memories, flat-panel displays, liquid-crystal displays (LCDs), thin-film magnetic heads, micro-electromechanical devices (MEMS), etc. Also, for instance in a flat panel display, the present apparatus may be used to assist in the creation of a variety of layers, e.g. a thin film transistor layer and/or a color filter layer.

Although specific reference is made above to the use of embodiments of the invention in the context of optical lithography, it will be appreciated that the invention can be used in other applications, for example imprint lithography, where the context allows, and is not limited to optical lithography. In imprint lithography a topography in a patterning device defines the pattern created on a substrate. The topography of the patterning device can be pressed into a layer of resist supplied to the substrate whereupon the resist is cured by applying electromagnetic radiation, heat, pressure or a combination thereof. The patterning device is moved out of the resist leaving a pattern in it after the resist is cured.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

What is claimed is:

1. A method for obtaining information indicative of uniformity of a projection system of a lithographic apparatus, comprising:
(a) directing a beam of radiation toward the projection system, such that the beam of radiation passes from a first end of the projection system to a second end of the projection system;
(b) directing the beam of radiation back through the projection system, such that the beam of radiation passes back from the second end of the projection system to the first end of the projection system; and
(c) detecting at least a part of the beam of radiation after the beam of radiation has passed back through the projection system to obtain information indicative of the uniformity of the projection system.

2. The method of claim 1, further comprising:
introducing an image reduction factor into the beam of radiation passing through the projection system from the first end of the projection system to the second end of the projection system; and
introducing an image magnification factor into the beam of radiation passing through the projection system from the second end of the projection system to the first end of the projection system.

3. The method of claim 2, wherein the image reduction factor is substantially equal to the inverse of the image magnification factor.

4. The method of claim 1, wherein step (b) comprises reflecting the beam of radiation off a substrate provided with a reflective surface, a substrate table provided with a reflective surface, or a substrate holder provided with a reflective surface.

5. The method of claim 1, before step (b) further comprising:
using a beam directing apparatus to direct the beam of radiation to the detector.

6. The method of claim 5, wherein the beam directing apparatus comprises a first surface and a second surface, the first surface being arranged to transmit the beam of radiation, and the second surface being arranged to reflect to the radiation beam.

7. The method of claim 5, wherein the beam directing apparatus comprises a semi-transparent mirror.

8. The method of claim 5, wherein the using step comprises:
allowing the beam of radiation to pass through the beam directing apparatus before the beam of radiation passes from the first end of the projection system through to the second end of the projection system; and
reflecting the beam of radiation after the beam of radiation has passed from the second end of the projection system through to the first end of the projection system.

9. The method of claim 5, further comprising positioning the beam directing apparatus at a location substantially coincident with a path of the beam of radiation between a patterning device and the projection system.

10. The method of claim 1, wherein the detecting step comprises detecting at least one of:
a field uniformity of the at least a part of the beam of radiation;
a change in the field uniformity of the at least a part of the beam of radiation;
a pupil uniformity of the at least a part of the beam of radiation; or
a change in the pupil uniformity of the at least a part of the beam of radiation.

11. The method of claim 1, wherein the detecting step comprises detecting at least one of:
an intensity distribution of the at least a part of the beam of radiation;
a change in the intensity distribution of the at least a part of the beam of radiation;
an angular intensity distribution of the at least a part of the beam of radiation;
a change in the angular intensity distribution of the at least a part of the beam of radiation;
a polarization of the at least a part of the beam of radiation;
a change in the polarization of the at least a part of the beam of radiation;
a pupil shape or mode of the at least a part of the beam of radiation; or
a change in the pupil shape or mode of the at least a part of the beam of radiation.

12. A lithographic apparatus, comprising:
an illumination system configured to produce a beam of radiation;
a patterning device configured to pattern the beam of radiation;
a projection system configured to project the patterned beam onto a target portion of a substrate;
a first directing apparatus configured to direct the patterned beam toward the projection system, wherein the patterned beam passes from a first end of the projection system to a second end of the projection system;
a second directing apparatus arranged to direct the patterned beam that has passed through the projection system back through the projection system, wherein the patterned beam passes back from the second end of the projection system to the first end of the projection system; and
a detector, wherein the detector detects at least a part of the patterned beam to obtain information indicative of the uniformity of the projection.

13. The lithographic apparatus of claim 12, wherein the second directing apparatus comprises a substrate provided with a reflective surface, a substrate table provided with a reflective surface, or a substrate holder provided with a reflective surface.

14. The lithographic apparatus of claim 12, further comprising a beam directing apparatus arranged to direct the patterned beam to the detector.

15. The lithographic apparatus of claim 14, wherein the beam directing apparatus comprises a first surface and a second surface, wherein the first surface is arranged to transmit the patterned beam, and wherein the second surface is arranged to reflect to the radiation beam.

16. The lithographic apparatus of claim 14, wherein the beam directing apparatus comprises a semi-transparent mirror.

17. The lithographic apparatus of claim 14, wherein the beam directing apparatus is substantially coincident with a path of the patterned beam and positioned between the patterning device and the projection system

18. The lithographic apparatus of claim 12, wherein the detector measures at least one of:
a field uniformity of the at least a part of the patterned beam;
a change in the field uniformity of the at least a part of the patterned beam;
a pupil uniformity of the at least a part of the patterned beam; or
a change in the pupil uniformity of the at least a part of the patterned beam.

19. The lithographic apparatus of claim 12, wherein the detector measures at least one of:
an intensity distribution of the at least a part of the patterned beam;
a change in the intensity distribution of the at least a part of the patterned beam;
an angular intensity distribution of the at least a part of the patterned beam;
a change in the angular intensity distribution of the at least a part of the patterned beam;
a polarization of the at least a part of the patterned beam;
a change in the polarization of the at least a part of the patterned beam;
a pupil shape or mode of the at least a part of the patterned beam; or
a change in the pupil shape or mode of the at least a part of the patterned beam.

20. A computer-readable medium containing instructions for controlling at least one processor by a method comprising:
directing a beam of radiation toward a projection system such that the beam of radiation passes from a first end of the projection system to a second end of the projection system;
directing the beam of radiation back through the projection system, such that the beam of radiation passes back from the second end of the projection system to the first end of the projection system; and
detecting at least a part of the beam of radiation after the beam of radiation has passed back through the projection system to obtain information indicative of the uniformity of the projection system.
